(19) United States
(12) Patent Application Publication
(10) Pub. No.: US 2023/0314049 A1
(43) Pub. Date: Oct. 5, 2023

(54) HEAT PUMP CAPABLE OF OPERATING AT SUBZERO AMBIENT TEMPERATURES

(71) Applicant: Brian R. Workman, Watertown, MA (US)

(72) Inventors: Brian R. Workman, Watertown, MA (US); Tyler J. Olson, Watertown, MA (US); Nicholas P. Roth, Watertown, MA (US)

(21) Appl. No.: 17/710,058

(22) Filed: Mar. 31, 2022

(51) Int. Cl. F25B 29/00; H05B 6/10; H05B 6/44

(52) U.S. Cl. CPC F25B 29/003; H05B 6/108; H05B 6/44; F25B 2700/197; F25B 2400/01; F25B 2700/2103; F25B 2500/31

(57) ABSTRACT

A heat pump that includes a compressing unit having an inlet and an outlet; a condensing unit in fluid communication with the outlet; an evaporating unit in fluid communication with the condensing unit; a variable induction heating unit disposed about a length of conduit fluidically coupling the evaporating unit and the inlet; a reversing valve disposed between the induction heating unit and the evaporating unit; and a metering device (e.g., expansion valve) disposed between the evaporating unit and the condensing unit. Advantageously, the variable induction heating unit may be selectively controllable to enable the heat pump to operate at an ambient temperature of −30 degrees Fahrenheit.

### BACKGROUND OF THE INVENTION

As universal green initiatives promote the use of clean energy (e.g., electricity generated by the sun, wind, water, and so forth) for heating needs as an alternative to the use of fossil fuels, problems have arisen involving the use of conventional heat pumps in colder climates where heat pumps cannot operate due to low (e.g., subzero) ambient temperatures.

For example, referring to FIG. 1 and FIG. 2, a conventional, thermodynamic cooling (e.g., air-conditioning or refrigeration) system and its associated pressure-enthalpy (PH) refrigeration cycle, respectively, are shown. In some embodiments, the cooling system 100 comprises a compressing unit 10, a condensing unit 20, an evaporating unit 30, and a metering device 40 (e.g., an expansion valve) that are in fluid communication for the purpose of circulating a (e.g., refrigerant) fluid that removes heat from the operating environment. Advantageously, when the heat pump functions as a cooling system 100, the reversing valve 50 disposed between the compressing unit 10 and the condensing unit 20 and between the compressing unit 10 and the evaporating unit 30 is configured so that fluid exiting the outlet 14 of the compressing unit 10 is channeled (e.g., via the reversing valve 50) to the condensing unit 20 and fluid exiting the evaporating unit 30 is channeled (e.g., via the reversing valve 50) to the inlet 12 of the compressing unit 10. More specifically, when the (e.g., refrigerant) fluid is in a liquid state, the (e.g., refrigerant) fluid absorbs heat, transitioning from the liquid state to a gaseous or vapor state. When the (e.g., refrigerant) fluid is in a gas/vapor state, the (e.g., refrigerant) fluid gives off heat as it transitions from the gaseous state to the liquid state.

For a cooling operation, the (e.g., refrigerant) fluid enters the compressing unit 10 (e.g., via an inlet 12) as a low-pressure, saturated gas/vapor (Point C). The compressing unit 10 compresses the low-pressure, saturated gas/vapor, such that, upon exiting the compressing unit (e.g., via an outlet 14), the (e.g., refrigerant) fluid comprises a high-pressure, saturated gas/vapor (Point D). The high-pressure, saturated gas/vapor travels through the reversing valve 50, entering the condensing unit 20 (Point E).

In the condenser 20, the high-pressure, saturated gas/vapor condenses, transitioning from a high-pressure, saturated gas/vapor to a high-pressure mixture consisting of a liquid portion and a gas/vapor portion to a saturated, high-pressure liquid. The condensation process (Point E to Point F) gives off heat to the (e.g., the exterior or outdoor) environment 70. The saturated, high pressure, condensed liquid exiting the condensing unit 20 (Point F) then travels to the metering device (e.g., expansion valve) 40 (Point G).

The metering device (e.g., expansion valve) 40 restricts the flow of the fluid, lowering the pressure, transitioning the saturated, high pressure, condensed liquid into a low-pressure mixture consisting of a liquid portion and a gas/vapor portion (Point A). The low-pressure mixture consisting of a liquid portion and a gas/vapor portion enters the evaporating unit 30 (Point A). The evaporating unit 30 (Point A) causes the low-pressure mixture consisting of a liquid portion and a gas/vapor portion to transition into a low-pressure saturated gas/vapor (Point B). The transition (Point A to Point B) absorbs heat from the (e.g., interior or indoor) environment 60. The heated, low-pressure saturated gas/vapor travels to the inlet 12 (Point C) of the compressing unit 10 and the cooling cycle is repeated.

Pressure, temperature, and enthalpy values for a typical cooling cycle are shown in TABLE I. More specifically, referring to TABLE I and FIG. 2, between Points A and B, a low-temperature, low-pressure fluid (e.g., a mixture of liquid and gas/vapor) from the metering device 40 enters the evaporating unit 30, causing an increase in enthalpy, which cools the (e.g., interior or indoor) environment 60. Between Points B and C, the low-temperature, low-pressure fluid (e.g., gas/vapor) becomes a saturated gas/vapor as it travels to the compressing unit 10, causing slight increases to the temperature and enthalpy.

Between Points C and D, the low-temperature, low-pressure fluid (e.g., saturated gas/vapor) enters the compressing unit 10, where the fluid is compressed to provide a high-temperature, high-pressure fluid (e.g., saturated gas/vapor). Between Points D and E, the high-temperature, high-pressure fluid (e.g., saturated gas/vapor) travels to the condensing unit 20, causing a slight decrease in enthalpy. Between Points E and F, the high-temperature, high-pressure fluid (e.g., saturated gas/vapor) transitions into a high-temperature, high-pressure fluid (e.g., saturated liquid), resulting in a more significant decrease in enthalpy. Heat from the condensing unit 20 is exchanged into the (e.g., exterior or outdoor) environment 70.

Between Points F and G, the temperature and enthalpy of the high-temperature, high-pressure fluid (e.g., saturated liquid) decreases slightly as the saturated liquid enters the metering device (e.g., expansion valve) 40. Between Points G and A, the high-temperature, high-pressure fluid (e.g., saturated liquid) transitions to a low-temperature, low-pressure fluid (e.g., liquid and gas/vapor mixture) that has approximately the same enthalpy. The cycle repeats at this point.

TABLE I
TYPICAL COOLING OPERATION

| | PRESSURE (PSIA) | TEMP (DEG F.) | ENTHALPY (BTU/lb) |
|---|---|---|---|
| A | 120 | 34 | 52.4 |
| B | 120 | 34 | 121.2 |
| C | 120 | 40 | 122.8 |
| D | 400 | 114 | 144 |
| E | 400 | 114 | 122.5 |
| F | 400 | 114 | 58.8 |
| G | 400 | 100 | 52.4 |

Referring to FIG. 3 and FIG. 4, a conventional, thermodynamic heating system and its associated pressure-enthalpy (PH) refrigeration cycle, respectively, are shown. In some embodiments, the heating system 200 also comprises a compressing unit 10, a condensing unit 20, an evaporating unit 30, and a metering device 40 (e.g., an expansion valve) that are in fluid communication for the purpose of circulating a (e.g., refrigerant) fluid that adds heat into the operating environment. Advantageously, when the heat pump functions as a heating system 200, the reversing valve 50 disposed between the compressing unit 10 and the condensing unit 20 and between the compressing unit 10 and the evaporating unit 30 is configured so that fluid exiting the outlet 14 of the compressing unit 10 is channeled (e.g., via the reversing valve 50) to the condensing unit 20 and fluid exiting the evaporating unit 30 is channeled (e.g., via the reversing valve 50) to the inlet 12 of the compressing unit 10.

For a heating operation, the (e.g., refrigerant) fluid enters the compressing unit 10 (e.g., via an inlet 12) as a low-pressure, low-temperature saturated gas/vapor. The compressing unit 10 compresses the (e.g., refrigerant) fluid, causing the fluid to transition from a low-pressure, low-temperature saturated gas/vapor into a high-pressure, high-temperature (e.g., superheated) saturated gas/vapor. Condensation of the (e.g., refrigerant) fluid gives off heat to the (e.g., the interior or indoor) environment 60. More specifically, the entering (e.g., refrigerant) fluid transitions from a high-pressure, high-temperature, saturated gas/vapor into to a saturated liquid.

The (e.g., refrigerant) fluid then travels to the metering device (e.g., expansion valve) 40. The metering device 40 restricts the flow of the (e.g., refrigerant) fluid, lowering the pressure and temperature. The low-temperature, low-pressure fluid (e.g., saturated liquid) then enters the evaporating unit 30, where it absorbs heat from the (e.g., exterior or outdoor) environment 70, changing the fluid from a low-temperature, low-pressure liquid to a low-temperature, low-pressure gas/vapor. The (e.g., refrigerant) fluid then travels to the inlet 12 of the compressing unit 10 and the heating cycle is repeated.

Pressure, temperature, and enthalpy values for a typical heating cycle are shown in TABLE II. More specifically, referring to TABLE II and FIG. 4, between Points A and B, a low-temperature, low-pressure fluid (e.g., a mixture of liquid and gas/vapor) from the metering device 40 (at Point G) enters the evaporating unit 30, causing an increase in enthalpy, which draws heat from the (e.g., exterior or outdoor) environment 70. Between Points B and C, the low-temperature, low-pressure mixture of liquid and gas/vapor becomes a low-temperature, low-pressure saturated gas/vapor as it travels through the reversing valve 50 to the compressing unit 10, causing slight increases to the temperature and enthalpy.

Between Points C and D, the low-temperature, low-pressure fluid (e.g., saturated gas/vapor) enters the compressing unit 10, where the fluid is compressed to provide a high-temperature, high-pressure (e.g., superheated) fluid (e.g., saturated gas/vapor). Between Points D and E, the high-temperature, high-pressure fluid (e.g., saturated gas/vapor) travels via the reversing valve 50 to the condensing unit 20, causing a slight decrease in enthalpy. Between Points E and F, the high-temperature, high-pressure fluid (e.g., saturated gas/vapor) transitions to a high-temperature, high-pressure fluid (e.g., saturated liquid), resulting in a more significant decrease in enthalpy. Heat from the condensing unit 10 is exchanged into the (e.g., interior or indoor) environment 60.

Between Points F and G, the temperature and enthalpy of the high-temperature, high-pressure fluid (e.g., saturated liquid) decreases slightly as the saturated liquid enters the metering device (e.g., expansion valve) 40. Between Points G and A, the high-temperature, high-pressure fluid (e.g., saturated liquid) transitions to a low-temperature, low-pressure fluid (e.g., mixture of liquid and gas/vapor) that has approximately the same enthalpy. The cycle repeats at this point.

TABLE II
TYPICAL HEATING OPERATION

| | PRESSURE (PSIA) | TEMP (DEG F.) | ENTHALPY (BTU/lb) |
|---|---|---|---|
| A | 40 | −21 | 64.2 |
| B | 40 | −21 | 116.5 |
| C | 40 | −15 | 117.8 |
| D | 500 | 131 | 194 |
| E | 500 | 131 | 121 |
| F | 500 | 131 | 67.4 |
| G | 500 | 125 | 64.2 |

Problematically, during the heating operation, there is a larger pressure and temperature change (i.e., delta) between the high side of the refrigeration cycle and the low side of the refrigeration cycle. Indeed, the suction temperature proximate the inlet 12 of the compressing unit 10 becomes more of a limiting factor as the ambient temperature in the (e.g., exterior or outdoor) environment 70 decreases further (e.g., to sub-zero temperatures), affecting the ability of the heat pump 200 to operate effectively.

### SUMMARY OF THE INVENTION

In a first aspect, the invention relates to a heat pump. In some embodiment, the heat pump includes a compressing unit having an inlet and an outlet; a condensing unit in fluid communication with the outlet; an evaporating unit in fluid communication with the condensing unit; a variable induction heating unit disposed about a length of conduit fluidically coupling the evaporating unit and the inlet; a reversing valve disposed between the induction heating unit and the evaporating unit; and a metering device (e.g., expansion valve) disposed between the evaporating unit and the condensing unit. In some implementations, the heat pump further includes a conduit system fluidically coupling the compressing unit, the condensing unit, the evaporating unit, and the induction heating unit, such that the conduit system is enclosed within a stainless steel conduit.

In some applications, the compressing unit consists of a single compressor or a plurality of compressors. In some variations, the compressing unit may be a positive displacement type (e.g., a scroll-type) compressor. In some implementations, the heat pump may also include one or more sensing devices that may be disposed proximate an outlet at the evaporating unit. The sensing devices may be adapted to provide measurements of one or more of: a fluid temperature, a fluid pressure, or an ambient temperature in an exterior environment.

In some implementations, the evaporating unit includes at least one of a source heat exchanger or a sink heat exchanger and/or the condensing unit includes at least one of a source heat exchanger, a sink heat exchanger or a load heat exchanger. In some variations, the reversing valve is further disposed between the compressing unit and the condensing unit.

Advantageously, the variable induction heating unit may be adapted to enable the heat pump to operate at an ambient temperature of −30 degrees Fahrenheit. In some implementations, the variable induction heating unit may include a stainless steel sleeve that is disposable about a length of conduit through which a refrigerant circulates through the heat pump and a coil of conductive wires (e.g., Litz wires) wrapped around the stainless steel sleeve. Optionally, the variable induction heating unit further includes an enclosure within which the stainless steel sleeve and the coil of conductive wires are disposable.

In a second aspect, the invention relates to a method of enabling a heat pump to operate in an external environment having a subzero ambient temperature (e.g., of up to −30 degrees Fahrenheit). In some implementations, the heat pump may include a compressing unit having an inlet and an outlet, a condensing unit in fluid communication with the outlet and disposed within an interior environment to be heated, an evaporating unit in fluid communication with the condensing unit and disposed in the external environment, and a variable induction heating unit in fluid communication with the evaporating unit and the inlet. In some applications, the method includes the steps of increasing, using the evaporating unit in the external environment, the enthalpy of a fluid; and selectively controlling the variable induction heating unit to heat the evaporated fluid before the evaporated fluid is introduced into the compressor. Alternate subzero ambient temperatures may range between −20 degrees Fahrenheit and −30 degrees Fahrenheit and/or between −10 degrees Fahrenheit and −30 degrees Fahrenheit.

In some applications, the method may also include sensing at least one of: a fluid temperature proximate an outlet of the evaporating unit, a fluid pressure proximate the outlet of the evaporating unit, or an ambient temperature of an exterior environment; and using sensed data to selectively control the variable induction heating unit. Advantageously, the variable induction heating unit may be adapted to minimize the amount of energy introduced into the heat pump.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows a schematic of a heat pump in a cooling mode of operation according to the prior art;

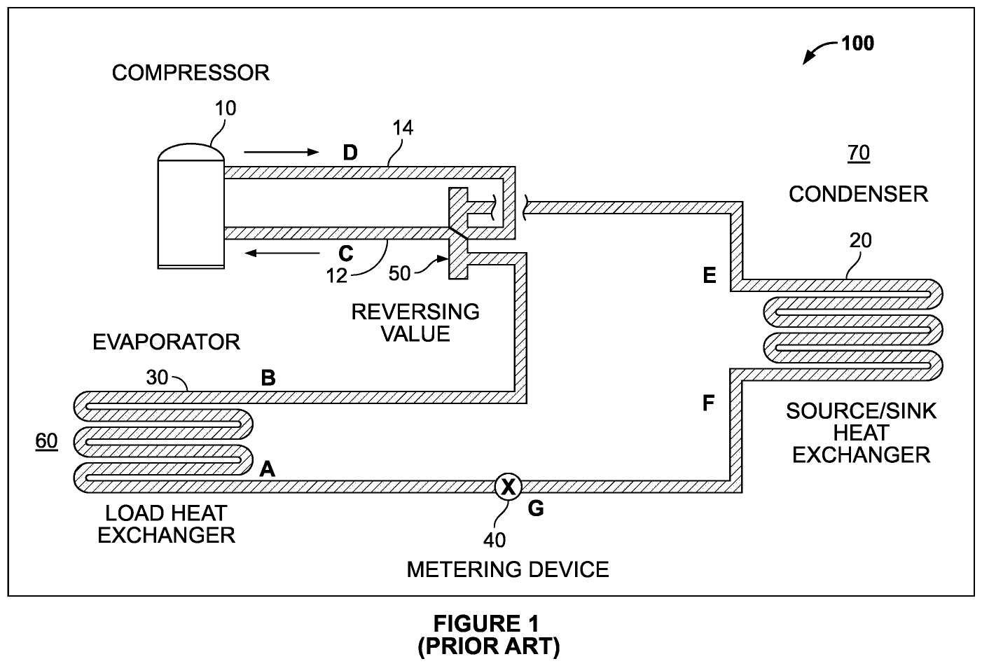

FIG. 2 shows a representative pressure vs. enthalpy relationship during a cooling cycle according to the prior art;

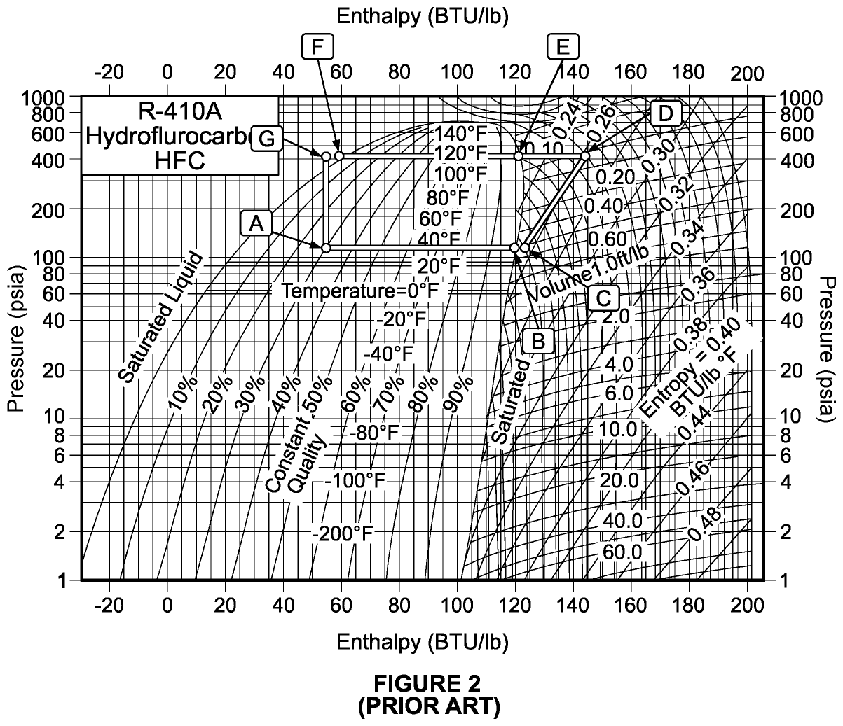

FIG. 3 shows a schematic of a heat pump in a heating mode of operation according to the prior art;

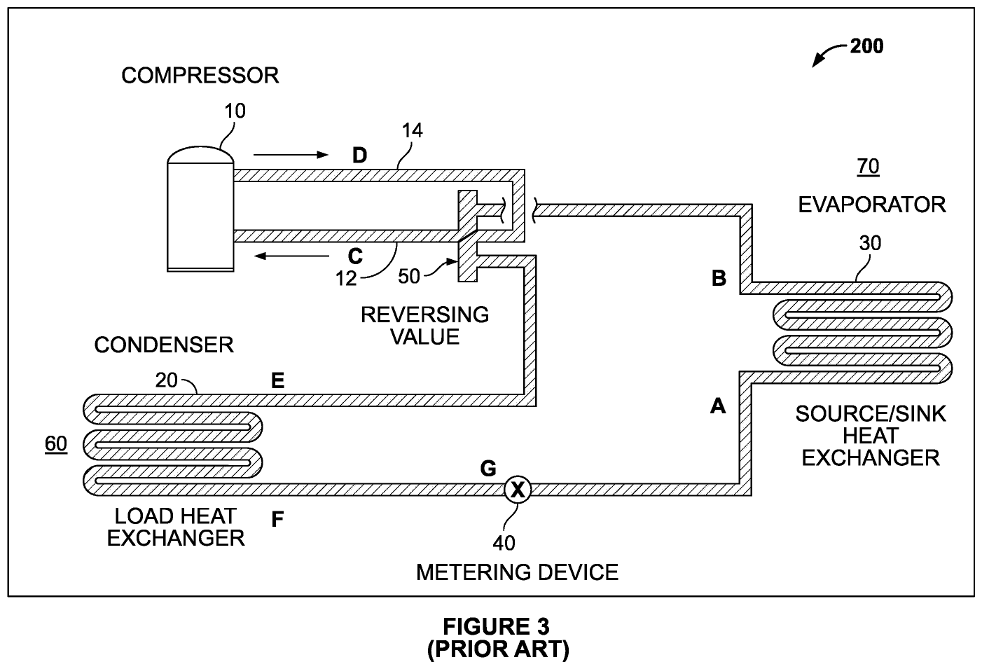

FIG. 4 shows a representative pressure vs. enthalpy relationship during a heating cycle according to the prior art;

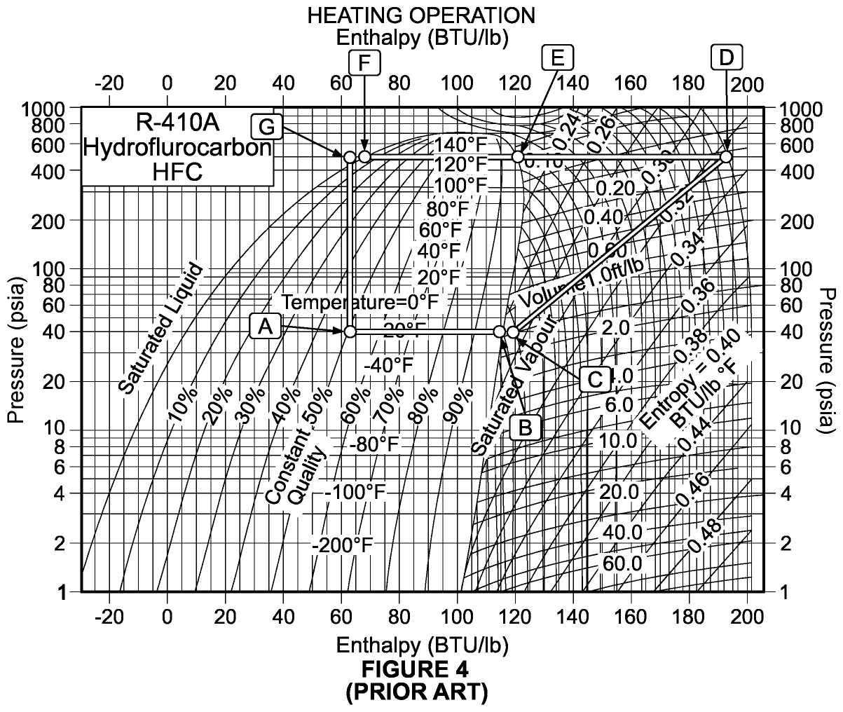

FIG. 5 shows an illustrative heat pump including an induction heating unit, in accordance with some embodiments of the present invention; and

FIG. 6 shows a representative pressure vs. enthalpy relationship during a heating cycle, in accordance with some embodiments of the present invention.

### DETAILED DESCRIPTION

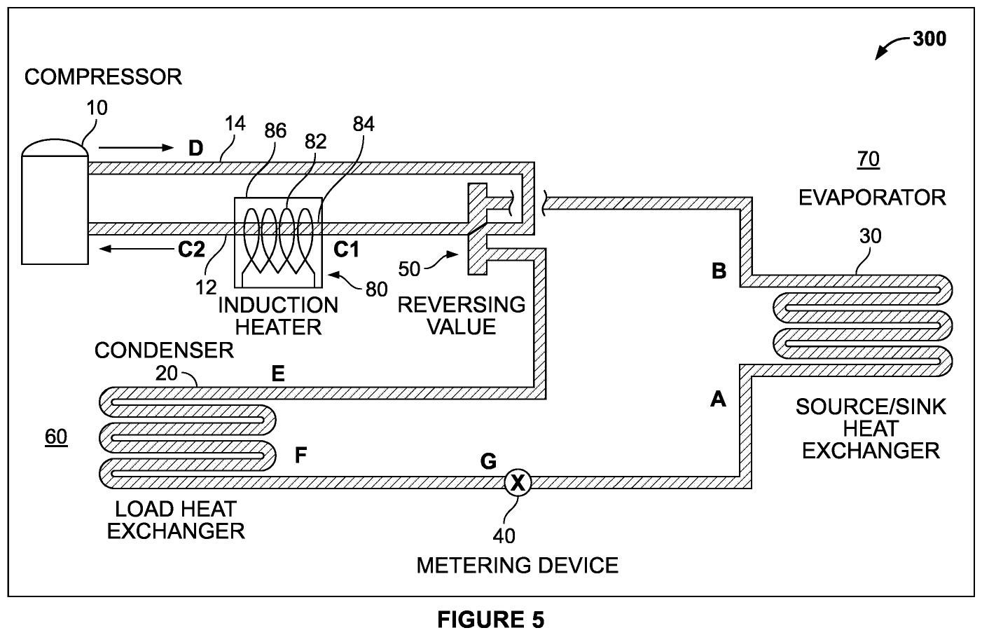

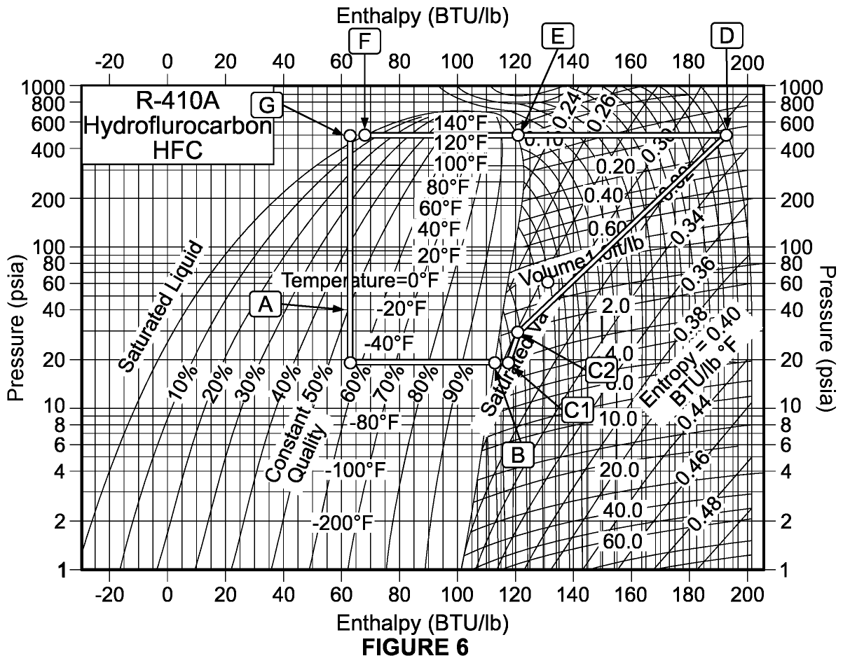

Referring to FIG. 5 and FIG. 6, an improved thermodynamic heating system and its associated pressure-enthalpy (PH) refrigeration cycle, respectively, are shown. In some embodiments, the improved heating system 300 comprises a compressing unit 10, a condensing unit 20, an evaporating unit 30, a metering device 40 (e.g., an expansion valve), and a (e.g., selectively-controllable) variable induction heating unit 80 that are in fluid communication for the purpose of circulating a (e.g., refrigerant) fluid that adds heat into the operating (e.g., interior or indoor) environment 60. Advantageously, when the heat pump functions as a heating system 300, the reversing valve 50 disposed between the compressing unit 10 and the condensing unit 20 and between the compressing unit 10 and the evaporating unit 30 is configured so that (e.g., refrigerant) fluid exiting the outlet 14 of the compressing unit 10 is channeled (e.g., via the reversing valve 50) to the condensing unit 20 and fluid exiting the evaporating unit 30 is channeled (e.g., via the reversing valve 50) to the inlet 12 of the compressing unit 10.

For a heating operation, the (e.g., refrigerant) fluid enters the compressing unit 10 (e.g., via an inlet 12) as a low-pressure, low-temperature saturated gas/vapor. The compressing unit 10 compresses the (e.g., refrigerant) fluid, causing the fluid to transition from a low-pressure, low-temperature saturated gas/vapor into a high-pressure, high-temperature (e.g., superheated) saturated gas/vapor. Advantageously, in some implementations, the compressing unit 10 may be a positive displacement type, e.g., a scroll-type, compressor; however, in other implementations, the compressing unit 10 may be a reciprocating compressor, a centrifugal-type compressor, and the like. Those of ordinary skill in the art can appreciate that positive displacement type compressors advantageously squeeze (i.e., compress) the refrigerant fluid, thereby increasing the pressure and temperature of the fluid to a desired value.

From the compressing unit 10, the high-pressure, high-temperature (e.g., superheated) saturated gas/vapor passes through the reversing valve 50 before entering the condensing unit 20. Condensation of the (e.g., refrigerant) fluid gives off heat to the (e.g., the interior or indoor) environment 60. The (e.g., refrigerant) fluid enters the condensing unit 20, that causes the (e.g., refrigerant) fluid to transition from a high-pressure, high-temperature, saturated gas/vapor to a saturated liquid.

The high-temperature, high-pressure, condensed fluid (e.g., saturated liquid) then travels to the metering device (e.g., expansion valve) 40, where the metering device 40 restricts the flow of the (e.g., refrigerant) fluid, lowering the pressure and temperature. The low-temperature, low-pressure fluid (e.g., saturated liquid) then enters the evaporating unit 30, where it absorbs heat from the (e.g., exterior or outdoor) environment 70, changing the fluid from a low-temperature, low-pressure liquid to a low-temperature, low-pressure gas/vapor.

The low-temperature, low-pressure gas/vapor then travels through the reversing valve 50 to the variable induction heating unit 80 where the temperature of the fluid (e.g., gas/vapor) is increased before the heated fluid (e.g., gas) is introduced into the inlet 12 of the compressing unit 10 and the heating cycle is repeated. Advantageously, one or more sensing devices may be disposed proximate the outlet of the evaporating unit 30 (as well as proximate the outlet of the condensing unit 60). Preferably, the one or more sensing devices are adapted to provide data on one or more of the temperature of the fluid, the pressure of the fluid, and/or the ambient temperature of the exterior (e.g., outdoor) environment 70. Such data may be providing to a general controller, which is structured and arranged to use the sensed and collected data to vary the degree to which the variable induction heating unit 80 increases the temperature and pressure of the (e.g., refrigerant) fluid to optimize the performance of the heat pump system 300. For example, in some applications, the variable induction heating unit 80 would be capable of varying its temperature to minimize the amount of energy (i.e., KW) introduced into the system 300 and exchanged to the (e.g., refrigerant) fluid, while still enabling desired operation of the compressing unit 10 (e.g., enough energy for the working fluid to reach the compressing unit 10 without formation of a vacuum). In some instances, the amount of energy delivered to the working fluid can be optimized to increase, decrease, and/or tune the capacity of the compressing unit 10.

Pressure, temperature, and enthalpy values for a typical heating cycle for an exemplary ambient temperature in the exterior environment 70 of about −30 degrees Fahrenheit are shown in TABLE III. Although the invention will be described for an ambient of about −30 degrees Fahrenheit, the invention is not to be limited to that temperature. Indeed, the exemplary ambient temperature in the exterior environment 70 may be, for example, about −25 degrees Fahrenheit, about −20 degrees Fahrenheit, about −15 degrees Fahrenheit, about −10 degrees Fahrenheit, between −10 degrees Fahrenheit and −15 degrees Fahrenheit, between −10 degrees Fahrenheit and −20 degrees Fahrenheit, between −10 degrees Fahrenheit and −25 degrees Fahrenheit, between −10 degrees Fahrenheit and −30 degrees Fahrenheit, between −15 degrees Fahrenheit and −20 degrees Fahrenheit, between −15 degrees Fahrenheit and −25 degrees Fahrenheit, between −15 degrees Fahrenheit and −30 degrees Fahrenheit, between −20 degrees Fahrenheit and −25 degrees Fahrenheit, between −20 degrees Fahrenheit and −30 degrees Fahrenheit, and between −25 degrees Fahrenheit and −30 degrees Fahrenheit.

More specifically, referring to TABLE III and FIG. 6, between Points A and B, a low-temperature (e.g., sub-zero), low-pressure fluid (e.g., a mixture of liquid and gas/vapor) from the metering device 40 (at Point G) enters the evaporating unit 30, causing an increase in enthalpy, which draws heat from the (e.g., exterior or outdoor) environment 70.

Between points B and C1, the low-temperature (e.g., sub-zero), low-pressure fluid (e.g., saturated gas/vapor) travels through the reversing valve 50 to the induction heating unit 80, causing slight increases to the temperature and enthalpy. Between Points C1 and C2, the low-temperature (e.g., sub-zero), low-pressure fluid (e.g., saturated gas/vapor) passes through the induction heating unit 80, increasing the temperature and slightly increasing the enthalpy. Between Points C2 and D, the low-temperature (e.g., sub-zero), low-pressure fluid (e.g., saturated gas/vapor) enters the compressing unit 10 via the inlet 12 and the fluid is compressed to provide a high-temperature, high-pressure (e.g., superheated) fluid (e.g., saturated gas/vapor).

Preferably, the system 300 does not discriminate and utilizes thermodynamic core principles for exchanging energy. More particularly, the energy put into the system 300 will move to a lower temperature/pressure. Thus, a specific quantity of energy added into the heating unit 80 in turn puts it into the refrigerant system.

Between Points D and E, the high-temperature, high-pressure (e.g., superheated) fluid (e.g., saturated gas/vapor) travels from the outlet 14 via the reversing valve 50 to the condensing unit 20, causing a slight decrease in enthalpy. Between Points E and F, the high-temperature, high-pressure fluid (e.g., saturated gas/vapor) transitions to a high-temperature, high-pressure fluid (e.g., a mixture of liquid and gas/vapor), resulting in a more significant decrease in enthalpy. Heat from the condensing unit 20 is exchanged into the (e.g., interior or indoor) environment 60.

Between Points F and G, the temperature and enthalpy of the high-temperature, high-pressure fluid (e.g., saturated liquid) decreases slightly as the saturated liquid exiting the condensing unit 20 enters the metering device (e.g., expansion valve) 40. Between Points G and A, the high-temperature, high-pressure fluid (e.g., saturated liquid) passes through the metering device 40, transitioning to a low-temperature (e.g., sub-zero), low-pressure fluid (e.g., mixture of liquid and gas/vapor) that has approximately the same enthalpy. The cycle repeats at this point.

TABLE III
HEATING OPERATION WITH INDUCTION HEATER

| | PRESSURE (PSIA) | TEMP (DEG F.) | ENTHALPY (BTU/lb) |
|---|---|---|---|
| A | 22 | −46 | 64.2 |
| B | 22 | −46 | 113.8 |
| C1 | 22 | −40 | 114.9 |
| C2 | 30 | −21 | 117.6 |
| D | 500 | 131 | 194 |
| E | 500 | 131 | 121 |
| F | 500 | 131 | 67.4 |
| G | 500 | 131 | 64.2 |

Assuming that, in one implementation, the condensing unit capacity, i.e., the heat moved by the condensing unit 20, is about 173,900 BTU/hours (BTUH) and the evaporating unit capacity, i.e., the heat moved by the evaporating unit 30, is about 71,570 BTUH, the mass flow rate is about 1340 lb/hr. From TABLE III (and FIG. 6), the change in enthalpy (i.e., the enthalpy delta) from C2 to C1 is about 2.7 BTU/lb; hence, mathematically, the induction heating unit capacity would be equal to the mass flow rate (1340 lb/hr) times the enthalpy delta (2.7 BTU/lb) or about 3619 BTUH.

As shown in TABLE IV, adding an induction heating unit 80 to the heat pump 300 may yield a coefficient of performance (COP), i.e., a ratio of the energy produced (out) to the energy used (in), of about 1.45.

TABLE IV
HEATING COP

| | |
|---|---|
| Heating BTUH | 173900 |
| Heating kW | 50.97 |
| Compressor kW | 30.43 |
| Heater kW | 1.06 |
| Fan kW | 3.56 |
| Total kW | 35.05 |
| Calculated COP | 1.45 |

Advantageously, the induction heating unit 80 may be structured and arranged to input heat into the refrigeration system to keep the heat pump system 300 online despite relatively low (e.g., subzero) ambient temperatures (e.g., in the exterior environment 70). The amount of heat input into the refrigeration system depends on the size of the overall system 300, the ambient temperature, compressor operating ranges, and the number of operating compressing units 10. Thus, the variable induction heating unit 80 may be sized based on the system size, the minimum operating compressor temperatures, the number of compressors, and the ambient temperature.

In some implementations, the induction heating unit 80 may be a variable temperature induction heating unit 80 capable of warming the (e.g., refrigerant) fluid to simulate warmer (e.g., exterior) ambient conditions than are actually present in the exterior (i.e., outdoor) environment 70. For example, to optimize the performance of the heat pump system 300, the variable induction heating unit 80 may be structured and arranged to be able to vary its temperature to minimize the amount of energy (i.e., KW) introduced into the system 300 and exchanged to the (e.g., refrigerant) fluid. Additionally, the variable induction heating unit 80 may be configured to remain in an ON state to aid in the additional capacity of the system 300 at temperatures above the compressor operating envelope.

Advantageously, the variable (e.g., selectively controllable) induction heating unit 80 would have the capability to vary the heat applied to the (e.g., refrigerant) fluid exiting the evaporating unit 30 using a master controller and control logic. Indeed, a sophisticated control sequence may be used to utilize and control the variable (e.g., selectively controllable) induction heating unit 80 in any suitable conditions. More specifically, control of the variable (e.g., selectively controllable) induction heating unit 80 may be modulated to account for the changing conditions in the exterior (e.g., outdoor) environment 70. For example, for the purpose of illustration rather than limitation, the control logic may be based upon sensed reference data, such as, ambient temperature, (e.g., refrigerant) fluid pressure, and/or (e.g., refrigerant) fluid temperature.

Advantageously, the variable (e.g., selectively controllable) induction heating unit 80 may be powered from the main power block in the heat pump 300. Power for the variable (e.g., selectively controllable) induction heating unit 80 may be consistent with the line voltage incoming power. Power for the variable (e.g., selectively controllable) induction heating unit 80 would not be limited to incoming power voltage and could be powered from the system 300 utilizing different voltages and phases.

As shown in FIG. 5, the variable (e.g., selectively controllable) induction heating unit 80 may be disposed between the input 12 of the compressing unit 10 and the reversing valve 50; hence, the induction heating unit 80 may be located in the interior (e.g., indoor) environment 60 or in the exterior (e.g., outdoor) environment 70.

The variable (e.g., selectively controllable) induction heating unit 80 would be operatively and electrically coupled to a power source. Variable (e.g., selectively controllable) induction heating units 80 may run on AC power that ranges from a few Hertz to 500 kHz and higher. The frequency chosen determines the penetration depth of the heat, with lower frequencies penetrating deeper. Frequencies for variable (e.g., selectively controllable) induction heating units 80 may be chosen at design time according to the particular work to be accomplished. Factors affecting the frequency selection may include, for the purpose of illustration, rather than limitation: the application specifics of the system 300, the thickness of the conduit, the quantity of refrigerant needing added temperature, and so forth.

In some implementations, an exemplary variable (e.g., selectively controllable) induction heating unit 80 may be structured and arranged to include an induction coil 82, a sleeve portion 84 and an enclosure 84. In some variations, the induction coil 82 may include a number of coils of a conductive (e.g., copper) wire that are wound around the conduit through which the refrigerant travels. In one application, the induction coil 82 may be fabricated using a multistrand wire or cable, such as a Litz wire. Typically, a Litz wire includes a number of wire strands that are twisted or woven together. Before being woven or twisted together, each of the individual wires may be insulated.

In some embodiments, the variable (e.g., selectively controllable) induction heating unit 80 may include a (e.g., stainless-steel) sleeve 84 that is mounted around the conductive (e.g., copper) conduit through which the (e.g., refrigerant) fluid passes. Advantageously, the (e.g., stainless steel) sleeve 84 minimizes potential corrosion between metals and, moreover, increases the magnetic field utilized by the induction heating unit 80.

The nature of the enclosure 84 depends, in part, on whether the variable (e.g., selectively controllable) induction heating unit 80 is mounted to the conduit within the interior (e.g, indoor) environment 60 or in the exterior (e.g., outdoor) environment 70. For example, if the variable (e.g, selectively controllable) induction heating unit 80 is to be mounted in an exterior (e.g., outdoor) environment 70, a NEMA 3R-type enclosure (manufactured by NEMA Enclosures of Houston, Texas) or similar enclosure may be used, whereas if the induction heating unit 80 is to be mounted within an interior (e.g., indoor) environment 60, a NEMA 1-type enclosure or similar enclosure may be used.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1.-14. (canceled)

15. A method of enabling a heat pump to operate in an external environment having a subzero ambient temperature, the heat pump for circulating a refrigerant fluid and comprising a compressing unit having an inlet and an outlet, a condensing unit in fluid communication with the outlet and disposed within an interior environment to be heated, an evaporating unit in fluid communication with the condensing unit and disposed in the external environment, and a variable induction heating unit disposed about a refrigerant fluid conduit fluidically coupling the evaporating unit and the inlet, the method comprising:
increasing, using the evaporating unit in the external environment, the enthalpy of the refrigerant fluid, such that the refrigerant fluid transitions into a saturated vapor state;
delivering the saturated vapor refrigerant fluid into the variable heating unit;
selectively controlling the variable induction heating unit to heat the saturated vapor refrigerant fluid, such that (i) the refrigerant fluid remains in the saturated vapor state; and (ii) the enthalpy of the saturated vapor refrigerant fluid increases; and
delivering the heated saturated vapor refrigerant fluid from the variable induction heating unit into the inlet of the compressing unit.

16. The method of claim 15 further comprising:
sensing at least one of a fluid temperature proximate an outlet of the evaporating unit, a fluid pressure proximate the outlet of the evaporating unit, or an ambient temperature of an exterior environment; and
using sensed data to selectively control the variable induction heating unit.

17. The method of claim 15, wherein the variable induction heating unit is adapted to minimize the amount of energy introduced into the heat pump.

18. The method of claim 15, wherein the subzero ambient temperature is −30 degrees Fahrenheit.

19. The method of claim 18, wherein the subzero ambient temperature is between −20 degrees Fahrenheit and −30 degrees Fahrenheit.

20. The method of claim 19, wherein the subzero ambient temperature is between −10 degrees Fahrenheit and −30 degrees Fahrenheit.
